(19) United States
(12) Patent Application Publication
(10) Pub. No.: US 2019/0228472 A1
(43) Pub. Date: Jul. 25, 2019

(54) SYSTEM AND METHOD FOR QUANTIFIABLE CATEGORIZATION OF CANDIDATES FOR ASSET ALLOCATION

(71) Applicant: Click IPO Holdings, LLC, Scottsdale, AZ (US)

(72) Inventors: Sukanta Ganguly, San Jose, CA (US); Scott Coyle, Scottsdale, AZ (US); James K. Farrelly, Scottsdale, AZ (US)

(21) Appl. No.: 16/253,657

(22) Filed: Jan. 22, 2019

Related U.S. Application Data
(60) Provisional application No. 62/620,485, filed on Jan. 23, 2018.

(51) Int. Cl. G06Q 40/06; G06Q 40/04; G06Q 40/02; G06F 9/54

(52) U.S. Cl. CPC G06Q 40/06; G06F 9/542; G06Q 40/02; G06Q 40/04

(57) ABSTRACT

An asset vector analysis (AVA) computing device retrieves, from a database, investor data relating to a plurality of individual investors and past investment activity of the plurality of investors. The device computes, for each individual investor, an investor score, and transmits a notification of a public offering of assets to at least some of the individual investors. The device receives, from the individual investors, a response indicating an amount of money the respective investor is willing to invest in the public offering. The device determines a total amount of assets available to the individual investors in the public offering. The device allocates a portion of the total amount of assets available to the individual investors based at least in part on the investor score of individual investors.

### CROSS-REFERENCE TO RELATED APPLICATION

This application claims the benefit of, and priority to U.S. Provisional Application Ser. No. 62/620,485 filed on Jan. 23, 2018, which is incorporated herein by reference in its entirety.

### BACKGROUND

This disclosure relates generally to allocation of assets, and more specifically, to a computer system configured to calculate, for each of a large number of disparate historical investors, a dynamic score vector that quantifies a likelihood the historical investor will engage in certain investing behavior with respect to a particular public offering.

Computer systems are used to increase the ease and efficiency of various processes. Computer systems include computing devices that are capable communicating with each other and making decisions (e.g., generate particular output values) in response to received input values. Computing devices make decisions by applying rules (e.g., a formula or algorithm) to received input values. However, computing devices are generally not capable of quantifying human behavior and decision-making, because human behavior and decision-making do not follow fixed rules and depend on individual human biases that are imperceptible to a computing device.

Currently, computer systems are not used for asset allocation in initial public offerings (IPOs) of shares in a company, secondary offerings of shares, or other public offerings of assets. In a public offering such as an IPO, an issuer sells shares of a corporation to investors, such as individual investors and institutional investors (e.g., banks, insurance companies, hedge funds, and mutual funds). Issuers generally favor investors who engage in certain investing behaviors, such as holding assets acquired in an IPO over a long period of time, so as to reduce volatility in the price of the assets. Individual investors typically will rely on a broker-dealer to be notified of and to acquire assets in an IPO. A broker-dealer, in deciding whether to notify an individual investor of an IPO, typically may use a computer system to manually review the records of individual investors with whom the broker-dealer has done business in the past, referred to as “historical investors” of the broker dealer, but then must make a subjective judgement as to the candidate investor's interest and ability to take part in the IPO. Further, a broker-dealer who has obtained the right to receive a certain quantity of assets in an IPO for offer to a plurality of individual investors must make subjective judgements in allocating the quantity of assets among the individual investors. These subjective judgements are often products of biases of the broker-dealers. Consequently, the offering of assets to individual investors is typically inefficient and reduces the value available to the issuer and the opportunities available to individual investors.

It is therefore desirable for a computer device to be capable of computing a likelihood of individual investors taking part in a particular public offering or otherwise engaging in particular investing behaviors, so that the process of allocating assets in the offering can be implemented by a computer system in a consistent and predictable manner that makes efficient use of computer resources and is favorable to issuers and investors across any number of broker-dealers.

### BRIEF DESCRIPTION

In one aspect, an asset vector analysis (AVA) computing device is provided. The AVA computing device includes at least one processor in communication with a database. The at least one processor is configured to retrieve investor data from the database, wherein the investor data relates to a plurality of individual investors and past investment activity of the plurality of individual investors. The at least one processor is further configured to compute, for each of the plurality of individual investors, an investor score using the investor data. The at least one processor is further configured to transmit, to at least some of the plurality of individual investors, a notification of a public offering of assets. The at least one processor is further configured to receive, from at least one of the plurality of individual investors, a response indicating an amount of money the at least one of the plurality of investors is willing to invest in the public offering. The at least one processor is further configured to determine a total amount of assets available to the individual investors in the public offering. The at least one processor is further configured to allocate, to the at least one of the plurality of investors, a portion of the total amount of assets available to individual investors based at least in part on the investor score of the at least one of the plurality of individual investors.

In another aspect, a computer-implemented method is provided. The computer-implemented method is implemented by an asset vector analysis (AVA) computing device including at least one processor in communication with a database. The method includes retrieving investor data from the database, wherein the investor data relates to a plurality of individual investors and past investment activity of the plurality of individual investors. The method also includes computing, for each of the plurality of individual investors, an investor score using the investor data. The method also includes transmitting, to at least some of the plurality of individual investors, a notification of a public offering of assets. The method also includes receiving, from at least one of the plurality of individual investors, a response indicating an amount of money the at least one of the plurality of investors is willing to invest in the public offering. The method also includes determining a total amount of assets available to the individual investors in the public offering. The method also includes allocating, to the at least one of the plurality of investors, a portion of the total amount of assets available to individual investors based at least in part on the investor score of the at least one of the plurality of individual investors.

In another aspect, a non-transitory computer-readable storage media is provided. The non-transitory computer-readable storage media has computer-executable instructions embodied thereon, wherein when executed by an asset vector analysis (AVA) computing device having at least one processor in communication with a database, the computer-executable instructions cause the AVA computing device to retrieve investor data from the database, wherein the investor data relates to a plurality of individual investors and past investment activity of the plurality of individual investors. The computer-executable instructions also cause the AVA computing device to compute, for each of the plurality of individual investors, an investor score using the investor data. The computer-executable instructions also cause the AVA computing device to transmit, to at least some of the plurality of individual investors, a notification of a public offering of assets. The computer-executable instructions also cause the AVA computing device to receive, from at least one of the plurality of individual investors, a response indicating an amount of money the at least one of the plurality of investors is willing to invest in the public offering. The computer-executable instructions also cause the AVA computing device to determine a total amount of assets available to the individual investors in the public offering. The computer-executable instructions also cause the AVA computing device to allocate, to the at least one of the plurality of investors, a portion of the total amount of assets available to individual investors based at least in part on the investor score of the at least one of the plurality of individual investors.

### BRIEF DESCRIPTION OF THE DRAWINGS

FIG. 1 is a schematic diagram of an example public asset offering illustrating an example asset vector analytics (AVA) computing device in communication with investor computing devices, broker-dealer computing devices, and an issuer computing device.

FIG. 2 is an example configuration of a client system that may be used to implement the investor computing devices, broker-dealer computing devices, and/or issuer computing device shown in FIG. 1 in accordance with an embodiment of the present disclosure.

FIG. 3 is an example configuration of a server system that may be used to implement the AVA computing device shown in FIG. 1 in accordance with an embodiment of the present disclosure.

FIG. 4A is a flow diagram illustrating an example process by which assets may be allocated in a public offering using the AVA computing device shown in FIG. 1.

FIG. 4B is a continuation of the flow diagram of FIG. 4A.

### DETAILED DESCRIPTION

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, systems and methods for allocating assets in a public offering, such as but not limited to an initial public offering (IPO) of shares in a company. The system described herein includes at least one asset vector analysis (AVA) computing device that allocates assets in a public offering. The AVA computing device may be in communication with at least one broker-dealer computing device, a large number of investor computing devices, and at least one issuer computing device.

The AVA computing device includes a processor in communication with a memory. The AVA computing device is further in communication with at least one database for storing information, such as historical investor data. The historical investor data may include data fields relating to past investment activity of the plurality of individual investors conducted through channels external to AVA computing device (e.g., through their associated broker-dealers). For example, such “external” historical investor data may include one or more of: average number of days holding an asset at peak value, average number of days holding an asset of a particular asset classification, percentage of the aftermarket accumulation of a particular asset, number of transactions per year, and/or average size of transaction per buying power at the time of the transaction. Historical investor data may also include data relating to previous investment activity with respect to public offerings previously offered through the AVA computing device, referred to as “internal” historical investor data. For example, such internal historical investor data may include one or more of: the fraction of assets actually purchased relative to the amount of assets the investor indicated a willingness to purchase at the candidate stage, the number of days the previous offering was held divided by a threshold number of days, a percentage of social share by the investor, and/or size of the order with respect to buying power. The threshold number of days is selected as a threshold time period for holding the assets that is associated with stability of the asset price after the offering. The percentage of social share by the investor is a percentage of offerings previously offered to the investor through the AVA computing device for which the investor has electronically shared information regarding the offering (e.g., by sharing that the investor has made an investment via a social media platform).

In the example embodiment, the AVA computing device utilizes the historical investor data to compute an investor score for each of the plurality of individual investors. The investor score may be dynamic, in that it is at times re-computed to include additional data, such as newly available data. For example, the investor score may be re-computed periodically (e.g., every 12 hours) or re-computed after the completion of each asset offering for which the investor receives notification. In some embodiments, the external and internal data are each used to generate respective vectors (e.g., an external vector and an internal vector). The external vector and the internal vector may be used to compute the investor score in a fashion that improves the processing speed and efficiency relative to other approaches for analyzing the underlying variables to evaluate investor behavior. This increased processing speed and efficiency enables, for example, (i) computation of investor scores for each candidate investor separately across multiple industry segments, enabling the use of different, industry-tailored scores for each current offering, and/or (ii) re-computation across a quite large number of investors doing business with any number of different broker-dealers as new investment behavior data becomes available. In addition, the vector approach disclosed herein enables an apples-to-apples comparison among investors at different broker-dealers. In some example embodiments, the internal vector is weighed more heavily over time in computing the investor score as more records are generated within the fields of the internal vector. For example, a threshold accumulation level within the AVA computing device (e.g., a certain number of transactions or a specific time range) may be used to determine when the internal vector should be weighed more heavily than the external vector.

In some embodiments, each component or factor of the vectors may calculated using only investor data associated with, for example, a specific classification of industry to which the asset offering is related (e.g., defense, energy, or technology). Thus, the investor score may accurately predict, for an asset offering of a particular classification, the behavior of the investor with respect to the particular asset offering (e.g., how long the investor will hold assets acquired in the offering). Consequently, the investor score may be used by issuers in an asset offering to determine the desirability in allocating assets to particular individual investors in the environment and to the aggregate of individual investors in the environment based on the industry to which the asset offering is related.

In the example embodiment, the AVA computing device is further configured to transmit notices of an asset offering to the plurality of individual investors in the environment. The notices of the asset offering may be transmitted to each of the plurality of investors in the environment, or to a subset of the plurality of investors (e.g., investors with an investor score above a threshold value with respect to the particular offering). In the example embodiment, the AVA computing device is further configured to receive responses from these candidate investors indicating a degree of investor willingness to take part in the offering. The responses may include, for example, a statement of an amount the candidate investor is willing to invest in the offering. Because the AVA computing device is in communication with the broker-dealer associated with each investor, the AVA computing device can determine whether each candidate investor is capable of investing the amount stated by the investor and decline to consider offers where the candidate investor is not capable of investing the stated amount (e.g., when the investor lacks adequate funds).

In the example embodiment, the AVA computing device is further configured to determine a total amount of assets available to allocate to individual investors indicating a willingness to invest in the public offering. The AVA computing device may generate and transmit an offer to the issuer including a number of responses received from individual candidate investors indicating a willingness to take part in the offering, an aggregate amount of funds stated by the candidate investors indicating a willingness to take part in the offering, and an aggregate investor score for the candidate individual investors indicating a willingness to take part in the offering. In response, the AVA computing device may receive from the issuer an amount of available assets that are available for allocation to the plurality of individual investors. The issuer, in determining the amount of assets to offer via the AVA computing device, may utilize the aggregate investor score computed by the AVA computing device or the individual investor scores for each of the plurality of candidate individual investors willing to take part in the offering. For example, the issuer may be offering shares of a technology corporation in an IPO. If the investor scores for the individual investors willing to take part in the IPO indicate that the individual investors are likely to purchase and hold technology stock over a long period of time, the issuer may decide a greater amount should be allocated via the AVA computing device because the investors are likely to engage in investing behavior favorable to the technology corporation (e.g., by holding the acquired technology corporation stock over a long period of time).

In the example embodiment, the AVA computing device is further configured to allocate the available assets to the candidate individual investors based on the investor score of each candidate investor. The AVA computing device may normalize the investor scores such that the sum of the normalized investor scores of the candidate investors equals the total amount of assets to be allocated to candidate individual investors. The AVA computing device may allocate the available assets so that each of the candidate individual investors taking part in the offering receives an allocation correlating to the individual investor's normalized investor score.

The technical problems addressed by the disclosure include at least one of: (i) inability of computing devices to quantify the likelihood a particular individual investor is willing to acquire assets in a particular public asset offering; inability of computing devices to quantify the financial capability of a particular individual investor to acquire assets in a particular offering; (iii) inability of a computing device to quantify the likelihood a particular investor will hold assets acquired in a particular offering for a particular period of time; (iv) inability of a computing device to allocate assets among individual investors in an offering based on the capability of each particular individual investor to acquire assets in the offering; (v) inability of a computing device to allocate assets among individual investors in an offering based on the likelihood a particular individual investor will hold assets acquired in a particular offering for a particular period of time; (vi) inability of a computing device to perform a typically subjective analysis of identifying and evaluating appropriate individual investors for a given public offering; and (vii) inability of a computing device to perform the very large number of computations required to update investor scores as needed to maintain accurate and efficient allocation of assets in each new offering.

The technical effects achieved by the systems and methods described herein include at least one of: (i) receiving investor information relating to a plurality of historical individual investors and past investment activity of the plurality of historical investors; (ii) storing the investor data in a database; (iii) computing, for each of the plurality of individual investors, an investor score; (iv) transmitting, to at least some of the plurality of individual investors, a notification of a public offering; (v) receiving, from at least one of the plurality of individual investors, a response indicating an amount of money the one of the plurality of individual investors is willing to invest in the public offering; (vi) determining a total amount of assets available to individual investors in the public offering; (vii) allocating, to the at least one of the plurality of investors, a portion of the total amount of assets available to the individual investors in the initial public offering based at least in part on the investor score of the one of the plurality of investors; (viii) calculating internal and external vectors for each of the individual investors based on historical investing behavior for offers made through and outside the AVA computing device, respectively; (ix) re-calculating the vectors as additional historical investor information becomes available; and (x) re-weighting the internal vector after a threshold amount of internal data (i.e., data accumulated in response to offers through the AVA computing device) is accumulated.

The resulting technical benefits achieved by the systems and methods of the disclosure include at least one of: (i) ability to quantify the likelihood a particular individual investor is willing to acquire assets in a public asset offering; ability to quantify the financial capability of a particular individual investor to acquire assets in a particular offering; (iii) ability to quantify the likelihood a particular individual investor will hold assets acquired in a particular offering for a particular period of time; (iv) ability to allocate assets among individual investors in an offering based on the financial capability of each particular investor to acquire assets in the offering; (v) ability to allocate assets among individual investors in an offering based on the likelihood a particular individual investor will hold assets acquired in a particular offering for a particular period of time; (vi) ability to efficiently calculate an objective measure of likelihood across differently situated individual investors each having a relationship with one of many broker-dealers that each individual investor is willing to participate in an asset offering; and (vii) ability to efficiently re-calculate the likelihoods for each individual investor in a short time frame as additional data on the investor's behavior becomes available.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

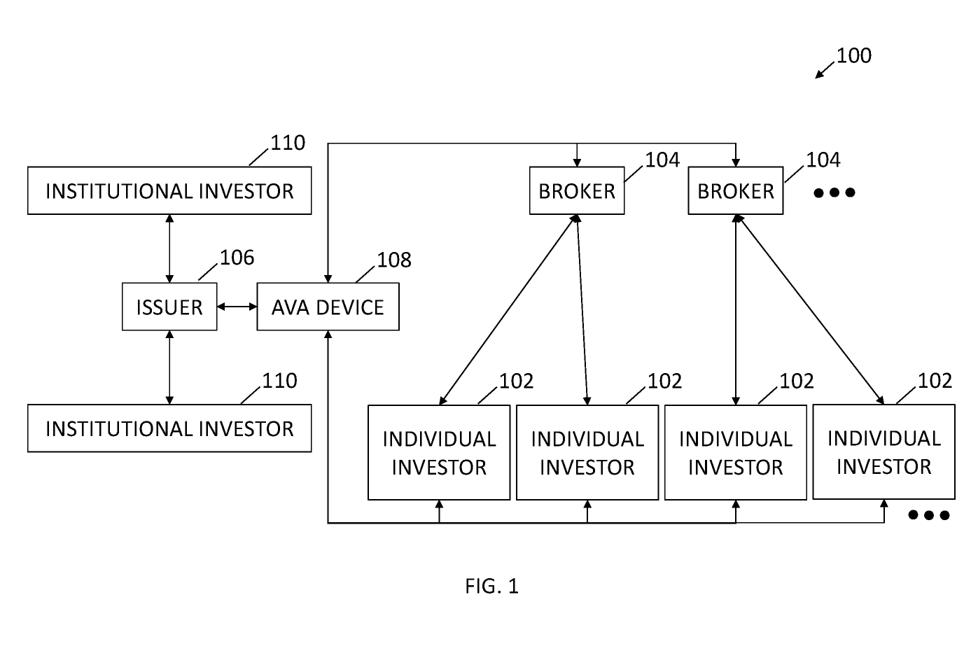

FIG. 1 is a schematic diagram illustrating an example environment 100. Environment 100 includes at least one investor computing device 102, at least one broker-dealer computing device 104, an issuer computing device 106, and an asset vector analysis (AVA) computing device 108.

Each investor computing device 102 is associated with an investor in environment 100. Each investor may be an individual who desires to purchase assets through public offerings. For example, the investor may wish to purchase stock in a corporation having an initial public offering. Each investor may have associated historical investor data corresponding to the investor's historical involvement in IPOs and other public offerings. Each investor computing device 102 is in direct communication with AVA computing device 108. For example, each individual investor registers with a service provided by AVA computing device 108. In response to the registration, AVA computing device 108 transmits notifications of upcoming public asset offerings to investor computing device 102. For example, but not by way of limitation, AVA computing device 108 transmits notifications to investor computing device 102 via a client application installed on investor computing device 102, or via a web page accessible to investor computing device 102 in response to investor computing device 102 transmitting log-in credentials to the web server. Investor computing device 102 transmits a response to AVA computing device 108 indicating the investor is willing to invest in the upcoming offering. Such a response may include a statement of an amount of money the investor wishes to invest in the upcoming offering. As shown in FIG. 1, in the example embodiment, environment 100 may include a plurality of investor computing devices 102 each associated with an individual investor. Some embodiments include offers transmitted to hundreds, thousands, tens of thousands, or millions of investor computing devices 102.

Each broker-dealer computing device 104 is associated with a corresponding broker-dealer in environment 100. The broker-dealer is an individual or organization that engages in the business of trading securities (e.g., stock) on behalf of the broker-dealer's customers (e.g., individual investors). Broker-dealer computing device 104 may store or generate historical investor data corresponding to investment activity of individual investors through the broker-dealer corresponding to broker-dealer computing device 104. Broker-dealer computing device 104 is in direct communication with AVA computing device 108 and with investor computing devices 102 of each customer/individual investor of the broker-dealer. Broker-dealer computing device 104 transmits historical investor data accumulated by broker-dealer computing device 104 to AVA computing device 108. As shown in FIG. 1, environment 100 may include a plurality of broker-dealer computing devices 104 each associated with a corresponding broker-dealer.

Issuer computing device 106 is associated with an issuer of a public offering such as an IPO. The issuer sells, for example, shares of stock in a corporation in exchange for funds. The issuer may select investors in the public offering based on, for example, a perceived financial capability and expected future investing behavior. As such, the issuer may be in communication with any number of institutional investors 110 and may allocate any suitable portion of the offering to institutional investors 110 outside the channels provided by AVA computing device 108. Additionally or alternatively, the issuer may consider allocating a portion of the offering to individual investors via AVA computing device 108. The issuer may consider the individual investors in environment 100 in aggregate, such that the issuer's decision on how much of the offering to allocate may be based on the aggregate perceived financial capability and expected future investing behavior of all the individual investors in environment 100. Issuer computing device 106 is in direct communication with AVA computing device 108 to receive data regarding the expected behavior of the individual investors. While one issuer computing device 106 is shown in FIG. 1, environment 100 may include a plurality of issuer computing devices 106 each associated with a corresponding issuer.

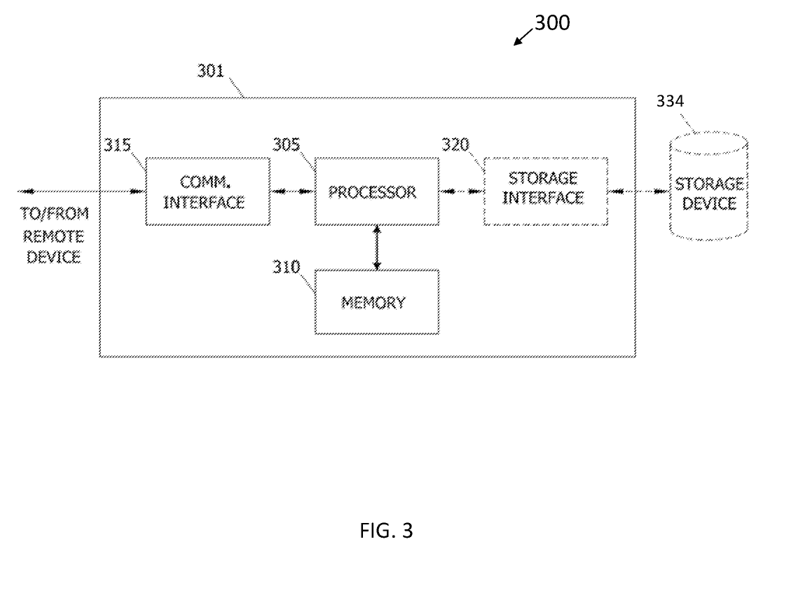

AVA computing device 108 is further in communication with at least one database (which may be implemented by a storage device 334 shown in FIG. 3) for storing information, such as historical investor data. In the example embodiment, the historical investor data is stored in at least one data structure having a plurality of data fields and a plurality of records, each record including a plurality of data values corresponding to the plurality of data fields. The historical investor data may include data fields relating to past investment activity of the plurality of individual investors executed through channels external to AVA computing device 108. In the example embodiment, the external historical investor data may be received from one or more of the broker-dealer computing devices 104 in communication with AVA computing device 108. For example, the external historical investor data fields may include one or more of: average number of days holding an asset at peak value, average number of days holding an asset of a particular asset classification, percentage of the aftermarket accumulation of a particular asset, number of transactions per year, and/or average size of transaction per buying power at the time of the transaction.

Historical investor data may also include data relating to previous investment activity with respect to public offerings through AVA computing device 108, referred to as “internal” historical investor data. In some embodiments, AVA computing device 108 is configured to capture data from previous investment activity of the plurality of individual investors conducted through AVA computing device 108, and store the captured data as at least a portion of the historical investor data in the database. For example, the internal historical investor data fields may include one or more of: the fraction of assets actually purchased relative to the amount of assets the investor indicated a willingness to purchase at the candidate stage, the number of days the previous offering was held divided by the threshold number of days, percentage of social share by the investor, and/or size of the order with respect to buying power. As discussed above, the percentage of social share by the investor is a percentage of offerings previously offered to the investor through the AVA computing device for which the investor has electronically shared information regarding the offering (e.g., by sharing that the investor has made an investment via a social media platform). In some embodiments, such sharing over electronic social media platforms by candidate individual investors is a behavior that the issuer and/or corporation offering the asset wish to encourage in order to build positive momentum for the offering.

AVA computing device 108 utilizes the historical investor data to compute an investor score for each of the plurality of investors. The investor score may be dynamic, in that it is at times re-computed to include additional data, such as newly available data that is added to the historical investor data in the database. For example, the investor score may be re-computed periodically (e.g., every 12 hours) or re-computed after the completion of each asset offering of which investor computing device 102 receives notification from AVA computing device 108. The investor score may be calculated based on a variety of different data fields in the historical investor data, such as but not limited to the average number of days holding an asset at peak value, the average number of days holding an asset of a particular asset classification, the percentage of the aftermarket accumulation of a particular asset, the number of transactions per year, and the average size of the transaction per buying power at the time of the transaction, obtained from investment transactions executed external to AVA device 108, such as via broker-dealer computing device 104. In other words, these records represent investing activity of individual investors with the broker-dealer outside of offerings made through AVA computing device 108. The investor score may further be calculated based on other data fields, such as the fraction of assets actually purchased relative to the amount of assets the investor indicated a willingness to purchase at the candidate stage, percentage of social share by the investor, and/or size of the order with respect to buying power, generated internally within AVA computing device 108 based on past activity of the candidate investor with AVA computing device 108.

In the example embodiment, the external and internal data are each used to generate respective vectors (referred to as an external vector and an internal vector) based on the corresponding data fields.

In the example embodiment, the external vector Eₖ is calculated for the kth candidate individual investor of n total candidate investors using the following factors derived from the external data fields:

X1ₖ=Average days of holding of an asset with a peak value;

X2ₖ=Average days of holding of an asset of the relevant particular asset classification;

X3ₖ=Percentage of the aftermarket accumulation of a particular asset;

X4ₖ=Number of transactions per year;

X5ₖ=Average size of the transaction per buying power at the time of the transaction.

For the given variables under observation, AVA computing device 108 calculates a weighted average of the external factors across the target set:

Eₖ=X1ₖ⊕X2ₖ⊕X3ₖ⊕X4ₖ⊕X5ₖ

where ⊕ is a mathematical operator ranging from a simple binary addition to any complex binary operation.

In alternative embodiments, additional external factors can be substituted or added. Moreover, in some embodiments, the set of external factors used to generate the external vector for the historical investors is modified over time (e.g., certain factors are added or dropped from the calculation of Eₖ). For example, the set of external factors may be modified in response to candidate individual investor behavior, as observed in response to current offers, not matching expectations. In some such embodiments, modification of the set of external factors is implemented automatically, for example by a suitable machine learning algorithm. Additionally or alternatively, modification of the set of external factors is implemented by a human operator.

In the example embodiment, the values for the factors used to calculate the external vector Eₖ for each candidate investor k are normalized across all n candidate investors, prior to calculating the external vector, in order to normalize the impact of the external vector on the investor score. For example, for the five external factors discussed above, the normalization of each factor may be implemented by:

Σ₁ⁿX1ₖ=1,Σ₁ⁿX2ₖ=1,Σ₁ⁿX3ₖ=1,Σ₁ⁿX4ₖ=1,Σ₁ⁿX5ₖ=1

where 1<k<n.

In the example embodiment, the internal vector Iₖ is calculated for the kth candidate individual investor using the following internal factors derived from the internal data fields (i.e., from at least one prior transaction of the kth candidate individual investor conducted through AVA computing device 108):

Y1ₖ=The fraction of assets actually purchased relative to the amount of assets the investor indicated a willingness to purchase at the candidate stage;

Y2ₖ=The number of days the previous offering was held divided by a threshold number of days;

Y3ₖ=Percentage of social share by the investor; and

Y4ₖ=Size of the order with respect to buying power.

For the given variables under observation, AVA computing device 108 calculates a weighted average of the internal data factors across the target set:

If Iₖ₋₁=0

Iₖ=(Y1ₖ⊕Y2ₖ⊕Y3ₖ⊕Y4ₖ)/4

else

Iₖ=(Iₖ₋₁⊙Y1ₖ⊕Y2ₖ⊕Y3ₖ⊕Y4ₖ)/4

where ⊙ is a differentiating mathematical operator (e.g, a multiplicative, differential, or additive mathematical operator) that produces normalization of the internal vector across investors.

In alternative embodiments, additional internal factors can be substituted or added. Moreover, in some embodiments, the set of internal factors used to generate the internal vector for the historical investors is modified over time (e.g., certain factors are added or dropped from the calculation of Iₖ). For example, the set of internal factors may be modified in response to candidate individual investor behavior, as observed in response to current offers, not matching expectations. In some such embodiments, modification of the set of internal factors is implemented automatically, for example by a suitable machine learning algorithm. Additionally or alternatively, modification of the set of internal factors is implemented by a human operator.

In the example embodiment, the external vector and the internal vector for the kth candidate individual investor are combined linearly (e.g., multiplied by weighting factors and summed) to obtain the investor score Uₖ for the kth candidate individual investor. In some example embodiments, the internal vector is weighed more heavily over time in computing the investor score as more records are generated within the fields of the internal vector. For example, a threshold accumulation level (e.g., a certain number of transactions or a specific time range) may be used to determine when and/or to what extent the internal vector should be weighed more heavily than the external vector.

In some embodiments, each factor of one or both vectors is calculated using only historical investor data from, for example, a different classification of industry to which the asset offering is related (e.g., defense, energy, or technology). For example, AVA computing device 108 queries the database of historical investor data for records in which the investment activity related to the industry classification associated with the current offering, and uses only the data field values in the returned records to calculate one or both of the external and internal vectors. In other words, the external and/or internal vectors used to allocate each current offering are calculated based only on historical investment data of the candidate investors for investments in the industry of the current offering. Thus, the investor score more accurately predicts, for an asset offering of a particular industry classification, the behavior of the candidate investor with respect to the particular asset offering (e.g., how long the investor will hold assets acquired in the offering).

The investor scores may be used by issuers in an asset offering to determine the desirability in allocating assets to particular individual investors in environment 100 and to the aggregate of individual investors in the environment. In some embodiments, ranking of the candidate investors in a two-dimensional model based on the external and internal vectors, as described above, enables computation of the investor score in a fashion that improves the processing speed and efficiency of AVA computing device 108 relative to other approaches for analyzing the same underlying variables to evaluate investor behavior. This increased processing speed and efficiency enables, for example, (i) computation of investor scores Uₖ by AVA computing device 108 for each candidate investor separately across multiple industry segments, enabling the use of different, industry-tailored scores for each current offering, and/or (ii) re-computation of the investor scores Uₖ by AVA computing device 108 in response to increasing amounts of historical investor data across a quite large number n of investors doing business with a large number of broker-dealers, such as hundreds, thousands, tens of thousands, or millions of candidate investors. In addition, the vector approach disclosed herein enables an apples-to-apples comparison among investors at different broker-dealers, eliminating the variable subjectivity of the different broker-dealers in selecting candidate individual investors for each offering.

As discussed above, AVA computing device 108 is further configured to transmit notices of an asset offering to investor computing devices 102 in environment 100. The notices of the asset offering may be transmitted to every investor computing device 102 in environment 100, or to a subset of the investor computing devices 102 (e.g., those associated with investors with an investor score above a threshold value with respect to the particular offering). In the example embodiment, AVA computing device 106 is further configured to receive responses from investor computing devices 102 indicating a degree of investor willingness to take part in the offering. The responses may include, for example, a statement of an amount the corresponding candidate investor is willing to invest in the offering. Because AVA computing device 108 is in communication with the broker-dealer computing device 104 associated with each investor, AVA computing device 108 can determine whether each candidate investor is capable of investing the amount stated and decline to consider offers where the candidate investor is not capable of investing the stated amount (e.g., when the candidate investor lacks adequate funds).

AVA computing device 108 is further configured to determine a total amount of assets available to allocate to individual investors indicating a willingness to invest in the public offering. In the example embodiment, AVA computing device 108 generates and transmits a purchase offer to issuer computing device 106 including, for example, a number of responses received from candidate individual investors indicating a willingness to take part in the offering, an aggregate amount of funds stated by the willing candidate investors, and an aggregate investor score for the willing candidate individual investors. In response, AVA computing device 108 may receive from issuer computing device 106 an amount of available assets that are available for allocation to the plurality of willing candidate individual investors. The issuer, in determining the amount of assets to offer via AVA computing device 108, may utilize the aggregate investor score computed by AVA computing device 108 and/or the individual investor scores for the willing candidate individual investors. For example, the issuer may be offering shares of a technology corporation in an IPO. If the investor scores for the individual investors willing to take part in the IPO indicate that the individual investors are likely to purchase and hold technology stock over a long period of time to the perceived benefit of the corporation, the issuer may decide a greater amount should be allocated via AVA computing device 108 because the candidate investors are likely to engage in investing behavior favorable to the technology corporation (e.g., by holding the acquired technology corporation stock over a long period of time).

AVA computing device 108 is further configured to allocate the total assets made available by issuer computing device 106 to the willing candidate individual investors in proportion to the investor score of each investor. For example, AVA computing device 108 normalizes the investor scores such that the sum of the normalized investor scores for the willing candidate investors equals the total amount of assets available to be allocated to individual investors. AVA computing device 108 then allocates the available assets so that each of the individual investors taking part in the offering purchases an allocation correlating to the individual investor's normalized investor score.

In some embodiments, because the allocation of the current offering by AVA computing device 108 is based at least in part on the extent to which each candidate investor's previous investment behavior resulted in high values for the external and/or internal vectors, AVA computing device 108 in effect rewards individual investors whose behavior in past investments was favorable to the corporation making the public offering with higher allocations of current offerings.

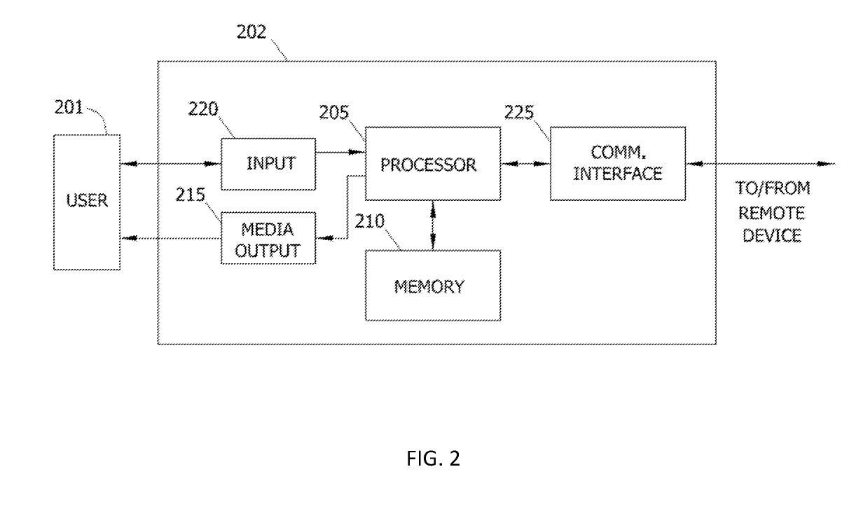

FIG. 2 illustrates an example configuration of a client system 202 that may be used to implement investor computing devices 102, broker-dealer computing devices 104, and/or issuer computing device 106 in accordance with one embodiment of the present disclosure. In the example embodiment, client system 202 is operable by a user 201, such as an investor, a broker-dealer, or an issuer. Client system 202 includes a processor 205 for executing instructions stored in a memory area 210. In some embodiments, executable instructions are stored in memory area 210. Processor 205 may, for example, include one or more processing units (e.g., in a multi-core configuration). Memory area 210 may, for example, be any device allowing information such as executable instructions and/or investor data to be stored and retrieved. Memory area 210 may further include one or more computer readable media.

In the example embodiment, client system 202 further includes at least one media output component 215 for presenting information to user 201. Media output component 215 may, for example, be any component capable of converting and conveying electronic information to user 201. For example, media output component 215 may be a display component configured to display component lifecycle data in the form of reports, dashboards, communications, and the like In some embodiments, media output component 215 includes an output adapter (not shown), such as a video adapter and/or an audio adapter, which is operatively coupled to processor 205 and operatively connectable to an output device (also not shown), such as a display device (e.g., a cathode ray tube (CRT), liquid crystal display (LCD), light emitting diode (LED) display, or “electronic ink” display) or an audio output device (e.g., a speaker or headphones).

In some embodiments, media output component 215 is configured to include and present a graphical user interface (not shown), such as a web browser and/or at least one client application, to user 201. The graphical user interface may include, for example, an interface for viewing and/or responding to offers presented through AVA computing device 108, and/or a wallet application for managing payment information. The graphical user interface may also include, for example, an interface for viewing and/or responding to offers presented through AVA computing device 108 In some embodiments, client system 202 includes an input device 220 for receiving input from user 201. User 201 may use input device 220 to, without limitation, select offers and/or enter a purchase request, or to access log-in credential information, and/or payment information. Input device 220 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, a iris reader/scanner, a retina reader/scanner, a profile scanner, or the like. A single component such as a touch screen may function as both an output device of media output component 215 and input device 220. User computing device 202 may also include a communication interface 225, which is communicatively connectable to a remote device such as broker-dealer computing device 104 and/or AVA computing device 108 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 are, for example, computer readable instructions for providing a user interface to user 201 via media output component 215 and, optionally, receiving and processing input from input device 220. A user interface may include, among other possibilities, a web browser, and at least one client application. Web browsers enable users, such as user 201, to display and interact with media and other information typically embedded on a web page or a website from AVA computing device 108. A client application allows user 201 to interact with a server application from AVA computing device 108. For example, instructions may be stored by a cloud service, and the output of the execution of the instructions sent to the media output component 215.

Processor 205 executes computer-executable instructions for implementing aspects of the disclosure. In some embodiments, the processor 205 is transformed into a special purpose microprocessor by executing computer-executable instructions or by otherwise being programmed.

FIG. 3 illustrates an example configuration of a server system 300 that may be used to implement AVA computing device 108 (shown in FIG. 1). In the example embodiment, server system 300 includes at least one server computing device 301, in electronic communication with at least one storage device 334. In the exemplary embodiment, server computing device 301 includes a processor 305 for executing instructions (not shown) stored in a memory area 310. In an embodiment, processor 305 may include one or more processing units (e.g., in a multi-core configuration) for executing instructions. The instructions may be executed within various different operating systems on the server system 300, such as UNIX®, LINUX® (LINUX is a registered trademark of Linus Torvalds), Microsoft Windows®, etc. More specifically, the instructions may cause various data manipulations on data stored in storage device 334 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

In the example embodiment, processor 305 is operatively coupled to a communication interface 315 such that server system 300 is capable of communicating with a remote device such as investor computing device 102, broker-dealer computing device 104, issuer computing device 106, or another AVA computing device 108. For example, communication interface 315 may receive requests from remote devices via the Internet.

In the example embodiment, processor 305 is also operatively coupled to a storage device 334, which may be, for example, any computer-operated hardware unit suitable for storing and/or retrieving data. Storage device 334 is used, for example, to store the database of historical investor data. In some embodiments, storage device 334 is integrated in server system 300. For example, server system 300 may include one or more hard disk drives as storage device 334. In certain embodiments, storage device 334 is external to server system 300. For example, server system 300 may include one or more hard disk drives as storage device 334. In other embodiments, storage device 334 is external to server system 300 and may be accessed by a plurality of server systems 300. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 305 is operatively coupled to storage device 334 via a storage interface 320. Storage interface 320 may include, for example, a component capable of providing processor 305 with access to storage device 334. In an exemplary embodiment, storage interface 320 further includes one or more of an Advanced Technology Attachment (ATA) adapter, a Serial ATA (SATA) adapter, a Small Computer System Interface (SCSI) adapter, a RAID controller, a SAN adapter, a network adapter, and/or any similarly capable component providing processor 305 with access to storage device 334.

Memory area 310 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

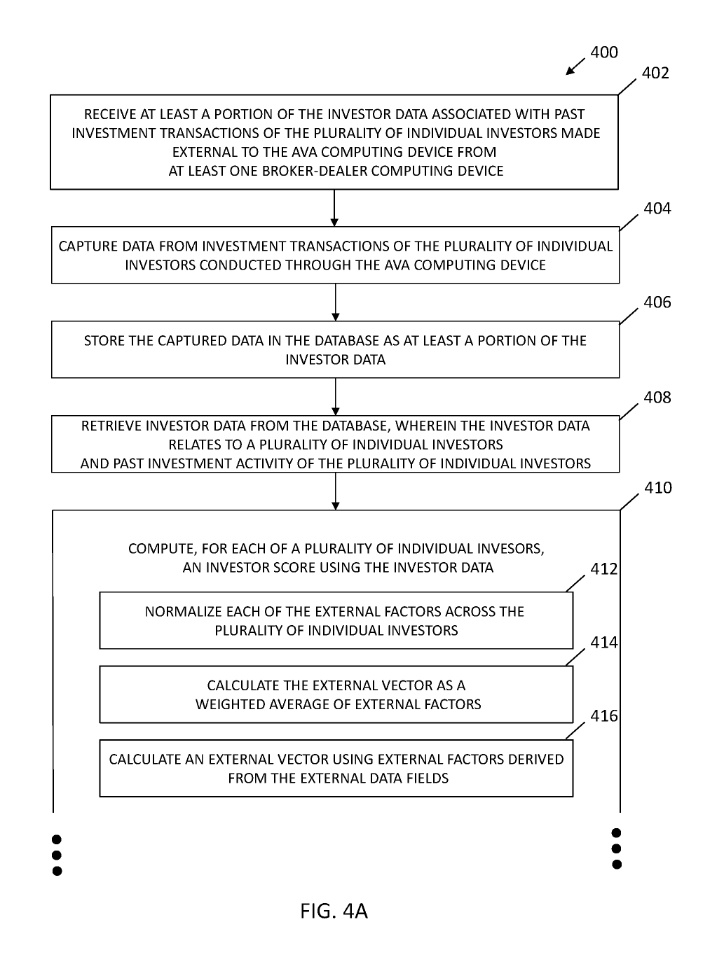

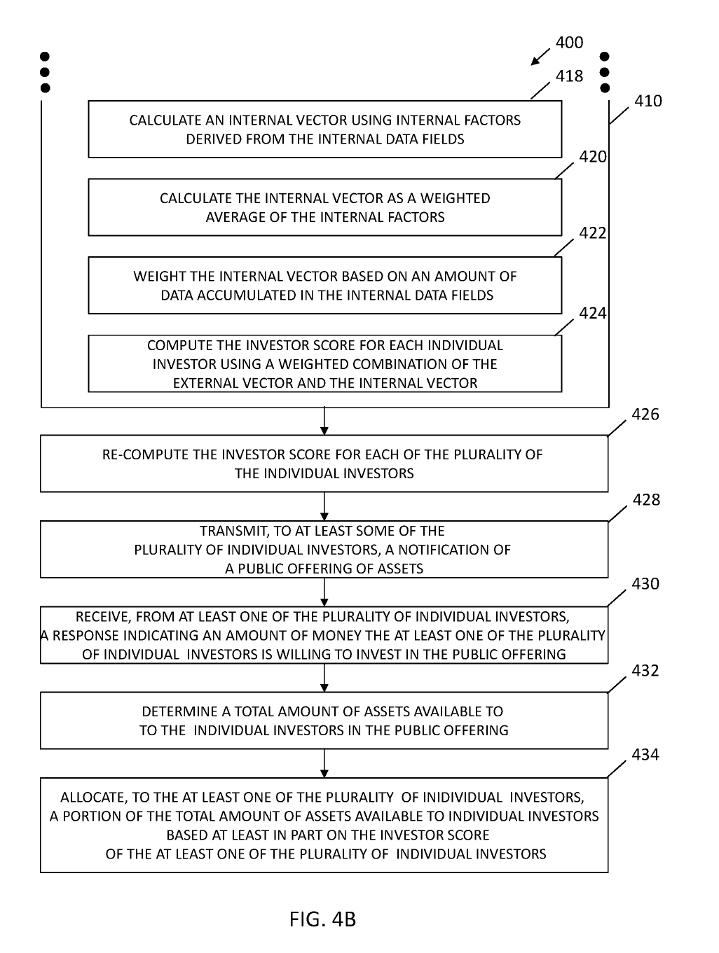

FIGS. 4A and 4B are a flow diagram illustrating an example process 400 by which assets may be allocated by an AVA computing device, which may be implemented using AVA computing device 108 (shown in FIG. 1).

In the example embodiment, method 400 includes retrieving 408 investor data from a database, wherein the investor data relates to a plurality of individual investors and past investment activity of the plurality of individual investors. Method 400 also includes computing 410, for each of the plurality of individual investors, an investor score using the investor data. Method 400 also includes transmitting 428, to at least some of the plurality of individual investors, a notification of a public offering of assets. Method 400 also includes receiving 430, from at least one of the plurality of individual investors, a response indicating an amount of money the at least one of the plurality of investors is willing to invest in the public offering. Method 400 also includes determining 432 a total amount of assets available to the individual investors in the public offering. Method 400 also includes allocating 434, to at least one of the plurality of investors, a portion of the total amount of assets available to individual investors based at least in part on the investor score for the at least one of the plurality of individual investors.

In some embodiments, method 400 also includes receiving 402 at least a portion of the investor data from at least one broker-dealer computing device, wherein the received at least portion of the investor data is associated with past investment transactions of the plurality of individual investors conducted through channels external to the AVA computing device.

In certain embodiments, method 400 also includes capturing 404 data from investment transactions of the plurality of investors conducted through the AVA computing device and storing 406 the captured data in the database as at least a portion of the investor data.

In some embodiments, step 410 also includes calculating 414 an external vector using external factors derived from external data fields. The external data fields are associated with past investment transactions of the plurality of individual investors conducted through channels external to the AVA computing device. In some such embodiments, step 410 also includes calculating 416 the external vector as a weighted average of external factors. Additionally or alternatively, step 410 also includes normalizing 412 each of the external factors across the plurality of individual investors, prior to calculating the external vector.

In certain embodiments, step 410 also includes calculating 418 an internal vector using internal factors derived from internal data fields. The internal data fields are associated with past investment transactions of the plurality of individual investors conducted through the AVA computing device. In some such embodiments, step 410 also includes calculating 420 the internal vector as a weighted average of the internal factors. Additionally or alternatively, step 410 also includes weighting 422 the internal vector based on an amount of data accumulated in the internal data fields.

In some embodiments, step 410 also includes computing 424 the investor score for each individual investor using a weighted combination of the external vector and the internal vector.

In certain embodiments, method 400 also includes re-computing 426 the investor score for each of the plurality of individual investors at least one of (i) periodically and (ii) after the completion of each offering for which the respective individual investor receives the notification from the AVA computing device.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a flexible system for various aspects of investor scoring. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

In addition, although various elements of the AVA computing device are described herein as including general processing and memory devices, it should be understood that the AVA computing device is a specialized computer configured to perform the steps described herein for the allocation of shares in a public offering based on a score that quantifies an individual investor's interest and ability to take part in the particular public offering.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. An asset vector analysis (AVA) computing device comprising at least one processor in communication with a database, the at least one processor configured to:
retrieve investor data from the database, wherein the investor data relates to a plurality of individual investors and past investment activity of the plurality of individual investors;
compute, for each of the plurality of individual investors, an investor score using the investor data;
transmit, to at least some of the plurality of individual investors, a notification of a public offering of assets;
receive, from at least one of the plurality of individual investors, a response indicating an amount of money the at least one of the plurality of investors is willing to invest in the public offering;
determine a total amount of assets available to the individual investors in the public offering; and
allocate, to the at least one of the plurality of investors, a portion of the total amount of assets available to individual investors based at least in part on the investor score of the at least one of the plurality of individual investors.

2. The AVA computing device of claim 1, wherein the at least one processor is further configured to receive at least a portion of the investor data from at least one broker-dealer computing device, wherein the received at least portion of the investor data is associated with past investment transactions of the plurality of individual investors conducted through channels external to the AVA computing device.

3. The AVA computing device of claim 1, wherein the at least one processor is further configured to:
capture data from investment transactions of the plurality of individual investors conducted through the AVA computing device; and
store the captured data in the database as at least a portion of the investor data.

4. The AVA computing device of claim 1, wherein the investor data includes (i) external data fields associated with past investment transactions of the plurality of individual investors conducted through channels external to the AVA computing device, and (ii) internal data fields associated with past investment transactions of the plurality of individual investors conducted through the AVA computing device, and wherein the at least one processor is further configured to:
calculate an external vector using external factors derived from the external data fields;
calculate an internal vector using internal factors derived from the internal data fields; and
compute the investor score for each individual investor using a weighted combination of the external vector and the internal vector.

5. The AVA computing device of claim 4, wherein the at least one processor is further configured to calculate the external vector as a weighted average of the external factors.

6. The AVA computing device of claim 4, wherein the at least one processor is further configured to normalize each of the external factors across the plurality of individual investors, prior to calculating the external vector.

7. The AVA computing device of claim 4, wherein the at least one processor is further configured to calculate the internal vector as a weighted average of the internal factors.

8. The AVA computing device of claim 1, wherein the at least one processor is further configured to weight the internal vector based on an amount of data accumulated in the internal data fields.

9. The AVA computing device of claim 1, wherein the at least one processor is further configured to re-compute the investor score for each of the plurality of individual investors at least one of (i) periodically and (ii) after the completion of each offering for which the respective individual investor receives the notification from the AVA computing device.

10. The AVA computing device of claim 1, wherein the public offering of assets is associated with an industry classification, and wherein the at least one processor is further configured to:
query the database for investor data records in which the past investment activity related to the industry classification; and
use only the returned records to calculate at least one of the external vector and the internal vector.

11. A computer-implemented method, said method implemented by an asset vector analysis (AVA) computing device comprising at least one processor in communication with a database, said method comprising:
retrieving, by the AVA computing device, investor data from the database, wherein the investor data relates to a plurality of individual investors and past investment activity of the plurality of individual investors;
computing, by the AVA computing device, for each of the plurality of individual investors, an investor score using the investor data;
transmitting, by the AVA computing device, to at least some of the plurality of individual investors, a notification of a public offering of assets;
receiving, by the AVA computing device, from at least one of the plurality of individual investors, a response indicating an amount of money the at least one of the plurality of investors is willing to invest in the public offering;
determining, by the AVA computing device, a total amount of assets available to the individual investors in the public offering; and
allocating, by the AVA computing device, to the at least one of the plurality of investors, a portion of the total amount of assets available to individual investors based at least in part on the investor score of the at least one of the plurality of individual investors.

12. The computer-implemented method of claim 11, further comprising receiving, by the AVA computing device, at least a portion of the investor data from at least one broker-dealer computing device, wherein the received at least portion of the investor data is associated with past investment transactions of the plurality of individual investors conducted through channels external to the AVA computing device.

13. The computer-implemented method of claim 11, further comprising:
capturing, by the AVA computing device, data from investment transactions of the plurality of individual investors conducted through the AVA computing device; and
storing, by the AVA computing device, the captured data in the database as at least a portion of the investor data.

14. A non-transitory computer-readable storage media having computer-executable instructions embodied thereon, wherein when executed by an asset vector analysis (AVA) computing device having at least one processor in communication with a database, the computer-executable instructions cause the AVA computing device to:
retrieve investor data from the database, wherein the investor data relates to a plurality of individual investors and past investment activity of the plurality of individual investors;
compute, for each of the plurality of individual investors, an investor score using the investor data;
transmit, to at least some of the plurality of individual investors, a notification of a public offering of assets;
receive, from at least one of the plurality of individual investors, a response indicating an amount of money the at least one of the plurality of investors is willing to invest in the public offering;
determine a total amount of assets available to the individual investors in the public offering; and
allocate, to the at least one of the plurality of investors, a portion of the total amount of assets available to individual investors based at least in part on the investor score of the at least one of the plurality of individual investors.

15. The non-transitory computer-readable storage media of claim 14, wherein the investor data includes (i) external data fields associated with past investment transactions of the plurality of individual investors conducted through channels external to the AVA computing device, and (ii) internal data fields associated with past investment transactions of the plurality of individual investors conducted through the AVA computing device, and wherein the computer-executable instructions further cause the AVA computing device to:
calculate an external vector using external factors derived from the external data fields;
calculate an internal vector using internal factors derived from the internal data fields; and
compute the investor score for each individual investor using a weighted combination of the external vector and the internal vector.

16. The non-transitory computer-readable storage media of claim 15, wherein the computer-executable instructions further cause the AVA computing device to calculate the external vector as a weighted average of the external factors.

17. The non-transitory computer-readable storage media of claim 15, wherein the computer-executable instructions further cause the AVA computing device to normalize each of the external factors across the plurality of individual investors, prior to calculating the external vector.

18. The non-transitory computer-readable storage media of claim 15, wherein the computer-executable instructions further cause the AVA computing device to calculate the internal vector as a weighted average of the internal factors.

19. The non-transitory computer-readable storage media of claim 14, wherein the computer-executable instructions further cause the AVA computing device to weight the internal vector based on an amount of data accumulated in the internal data fields.

20. The non-transitory computer-readable storage media of claim 14, wherein the public offering of assets is associated with an industry classification, and wherein the computer-executable instructions further cause the AVA computing device to:
query the database for investor data records in which the past investment activity related to the industry classification; and
use only the returned records to calculate at least one of the external vector and the internal vector.
